(19) United States
(12) Patent Application Publication
(10) Pub. No.: US 2011/0069238 A1
(43) Pub. Date: Mar. 24, 2011

(54) EMBEDDED RECYCLE CIRCUIT FOR HARNESSING LIGHT ENERGY

(75) Inventor: PABLO ESPINOSA, San Diego, CA (US)

(73) Assignees: Sony Corporation; Sony Electronics Inc.

(21) Appl. No.: 12/563,584

(22) Filed: Sep. 21, 2009

(51) Int. Cl. H04N 5/50; H04N 5/64

(52) U.S. Cl. 348/731; 348/836; 348/E05.097; 348/E05.128

(57) ABSTRACT

In an LCD, the lamp that is used to illuminate the liquid crystals also illuminates a solar cell in the display chassis to minimize wastage of light. The solar cell can be used to charge a battery for a standby power supply.

### FIELD OF THE INVENTION

The present invention relates to liquid crystal display (LCD) devices used to display a picture on a television screen or computer monitor while harnessing unused light source energy.

### BACKGROUND OF THE INVENTION

The active liquid crystal display (LCD) has been in use for over thirty-five years rather unchanged in function and structure. It is electronically-controlled optical device shaped into a flat panel and placed in front of a light source or reflector. The panel itself comprises an array of monochrome pixels, each of which consists of a layer of liquid crystals sandwiched between to transparent electrodes and two polarizing filters, whose axes of transmission are perpendicularly aligned.

In a black and white LCD, incident light passes through the first polarizer and contacts the liquid crystal, which refracts the light, thereby allowing it to pass through the second polarizer. The angle of refraction determines the amount of light passing through the second polarizer. Molecular structure of the liquid crystal, and the angle of refraction, is determined by the current applied by the transparent electrodes.

Color LCD's differ in that each pixel in divided into three subpixels that are colored by additional filters: red, blue, and green. Subpixels are controlled independently, yielding a vast number of possible colors. The liquid crystal structure itself, like the black and white LCD, is controlled by means of the transparent electrodes. The same refraction principles also apply.

The average amount of energy consumed by a modern LCD is less than that of a modern plasma television and slightly more than that consumed by CRT technology or DLP/rear projection televisions. Today, LCD TVs in the stand-by state (also the OFF state) consume anywhere from 0.1 W to 40 W, a variation due to updates being performed while the user is away from the TV. This can add up to a substantial amount of energy being consumed while the TV is not being used. Currently, a method of harnessing the light inside of the TV unused by the LCD panel does not exist.

### SUMMARY OF THE INVENTION

Accordingly, a display device includes a chassis, a display on the chassis, and a light source to illuminate the display. The display device may be a TV or computer. In the case of the TV, a tuner to receive external signals and a processor to convert the signal into an image are mounted on the chassis. A recycle circuit is implemented to harness unused illumination outputted by the light source and store the energy in a battery. A light converter, such as a solar panel, receives excess light from the light source. The battery can power a standby module necessary for updates to the display device and for processing a wireless command signal received from a remote control when a main power supply to the light source is deenergized. A DC/DC Buck/Boost circuit may be used to transfer energy from the light converter to the battery and standby system. By generating its own power, the display device can be disconnected from the electrical grid, thereby saving a significant amount of power for the consumer and the electric company.

In another aspect, a display apparatus includes a chassis holding a display including display elements and a light source in the chassis and positioned to provide illumination to the elements of the display. The illumination is necessary to cause the display to present demanded images. Some of the illumination is excess illumination that does not illuminate the elements of the display but nonetheless requires power to generate. A recycle circuit advantageously is positioned in the chassis to receive and recycle the excess illumination so that not all of the excess illumination is wasted.

In another aspect, a display device includes an electronic display requiring illumination to present a demanded image. A converter is separate from the display and requires illumination to generate electricity. At least one lamp provides illumination to the display to facilitate presentation of the demanded image thereon and also provides illumination to the converter to facilitate electricity production thereby.

In another aspect, a method includes using a non-solar light source to illuminate a visual display to enable the display to produce a demanded image thereon, and simultaneously with using the non-solar light source to illuminate a visual display, using the non-solar light source to charge at least one battery.

### BRIEF DESCRIPTION OF THE DRAWINGS

FIG. 1 is a perspective view of a TV, showing interior components schematically;

FIG. 2 is schematic side elevational diagram illustrating the relation between an LCD module and the harnessing of unused light energy;

FIG. 3 is a view of a computer with the exterior over-molding removed, showing interior components schematically;

FIG. 4 is a block diagram of an alternate embodiment; and

FIG. 5 is a block diagram of yet another alternate embodiment.

### DETAILED DESCRIPTION OF THE PREFERRED EMBODIMENT

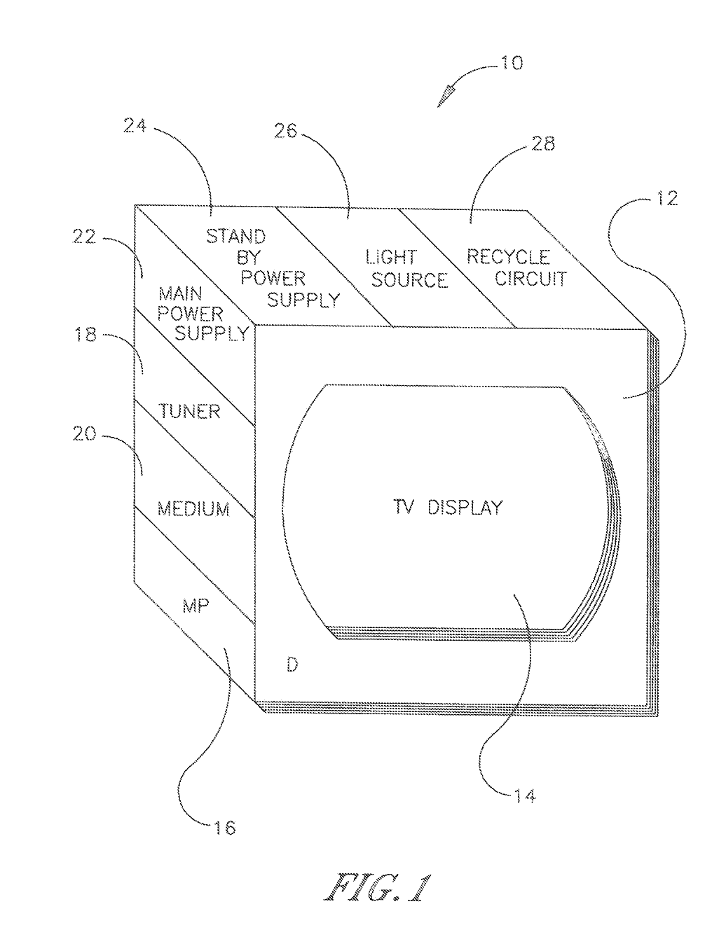

Referring initially to FIG. 1, a TV 10 includes a TV chassis 12 housing an LCD display panel 14 and processor 16. A TV tuner 18, mounted inside the TV 12, receives TV signals in a format presentable in the LCD display 14 under control of the processor 16. The processor 16 typically accesses one or more computer-readable media 20 such as but not limited to disk-based or solid state storage. A main power supply 22 and a standby power supply 24 typically are provided in the chassis 12 for purposes to be shortly disclosed.

For the LCD display 14 to present a demanded image, a light source 26 mounted in the chassis 12 generates light that illuminates the interior elements of the LCD display 14. The light source 26 may include, but is not limited to, a cold cathode fluorescent lamp (CCFL) that receives power from the main power supply 22. As set forth further below, a converter member is mounted on the chassis 12 as part of a recycle circuit 28 and receives light from the light source 26. The converter member, such as an amorphous silicon solar panel, translates the light energy into electrical energy that can be input into a standby power supply circuit 24 also inside the chassis. The standby power supply circuit 24 may include, but is not limited to, a DC/DC buck/boost circuit receiving electricity from the converter member and communicating with a standby power supply battery.

The converter member of recycle circuit 28 may include at least one solar cell. By housing the solar cell, or solar panel, inside the TV 10, the high intensity light source may be harnessed directly. The chassis 12 substantially blocks sunlight from impinging of the solar cell.

The standby power supply circuit 24 is necessary to keep the TV 10 active for updates and to provide standby power to process a wireless command signal received from a TV remote control when a main power supply to the light source 26 is deenergized. TV updates may include software upgrades, TV guide updates, system monitoring, etc. The standby power supply circuit 24 may include a battery charged by the converter member of the recycle circuit 28.

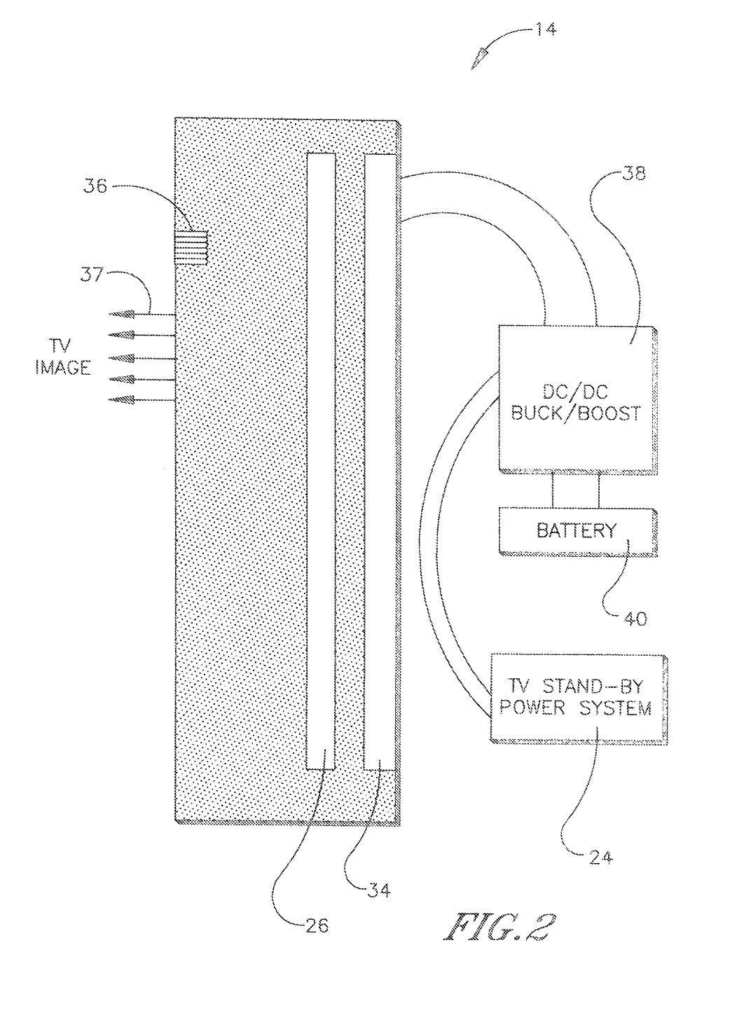

Now referring to FIG. 2, a diagram of the interior of a TV 10 is shown with the chassis 12 removed. The LCD display 14 is backlit by the light source 26 as shown. As mentioned above, the light source 26 can be established in some example non-limiting embodiments by a CCFL backlight module 32. Closely juxtaposed with the light source 26 on the side of the light source that is opposite from the display 14 is a converter member which may be established by an amorphous silicon solar panel 34, it being understood that the solar panel 34 can be part of the previously designated recycle circuit 28 shown in FIG. 1. Thus, the light source 26 illuminates not only LCD display elements 36, here shown only in part to represent the parallel orientation between the light source and LCD display panel on the TV display 14, but also the light source 26.

Each of the components of the overall LCD module may be mounted separately on the chassis 12 in orientations similar to what is shown in FIG. 2. The light from the light source accordingly is transformed by the LCD display elements 36, yielding a demanded image represented by arrows 37 while the solar panel 34 absorbs light energy transmitted by the light source 26 but not otherwise used to illuminate the display elements 36. In some implementations the electrical energy generated by the solar panel 34 is sent to a DC/DC Buck/Boost circuit 38, which is an intermediate member of the recycle circuit shown in FIG. 1. The Buck/Boost circuit 38 communicates with a battery 40. The battery provides standby power to process a wireless command signal received from a remote control when a main power supply to the light source is deenergized. These elements 38, 24, and 40 are mounted in the chassis 12 of the TV 10, but not necessarily in the relative orientation shown.

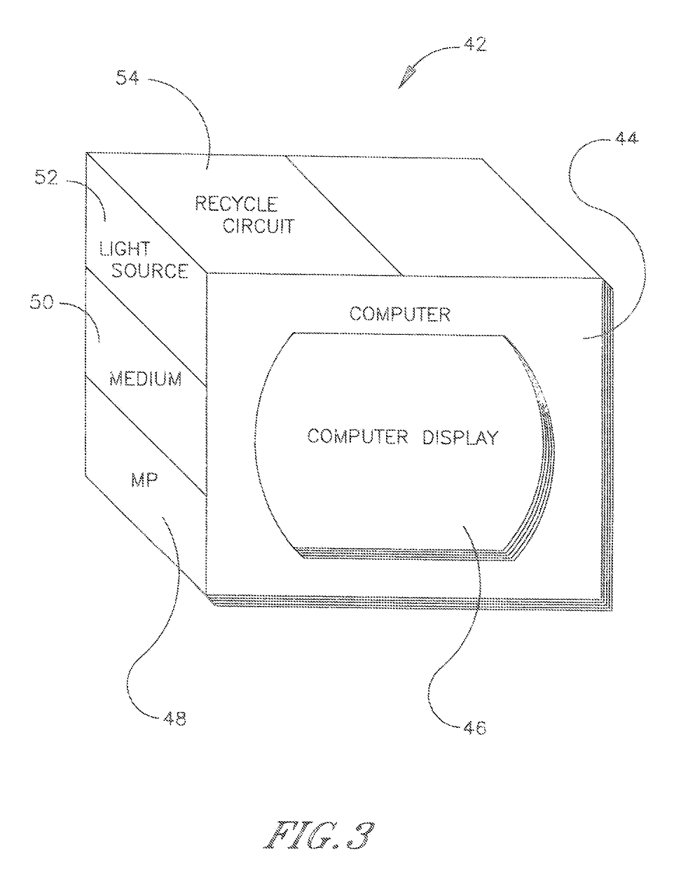

Moving in reference to FIG. 3, any display device, here a computer 42, with an electronic display, here computer display 46, requiring illumination to present a demanded image is exemplified. A computer chassis 44 encloses a processor 48, medium 50, light source 52, and recycle circuit 54 and supports the display 46.

The light source 52 consists of at least one lamp providing illumination to the display 46 to facilitate presentation of the demanded image thereon and providing illumination to a converter, which is integrated into the recycle circuit 54, to facilitate electricity production thereby. The light source 52 may be, but is not limited to, a CCFL. The converter member of the recycle circuit 54 may be, but is not limited to, an amorphous silicon solar panel. The computer chassis 44 substantially blocks sunlight from impinging on the converter member.

As was the case for the display shown in FIG. 1, the recycle circuit 54 in FIG. 3 includes an electrical storage device, such as a battery charged by the converter. The battery provides standby power for various non-limiting purposes, e.g., to process a wireless command signal received from a remote control when a main power supply to the lamp is deenergized. A DC/DC buck/boost circuit may be an intermediate member of the recycle circuit 54, receiving electricity from the converter and communicating with the battery.

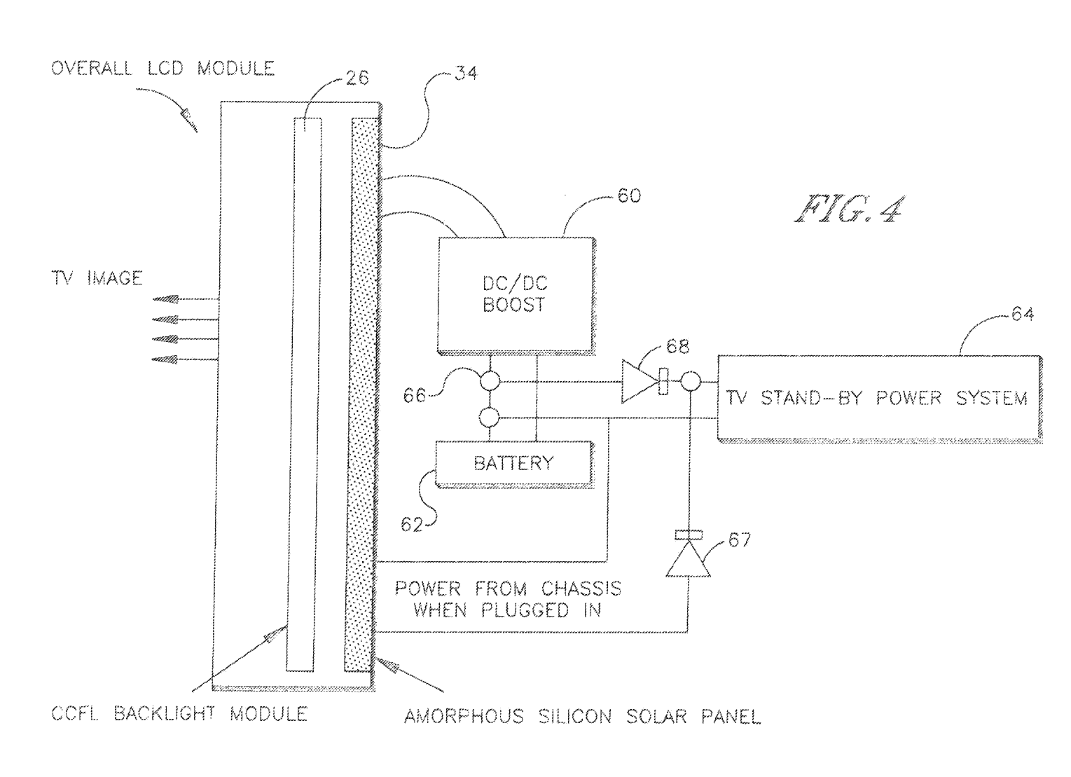

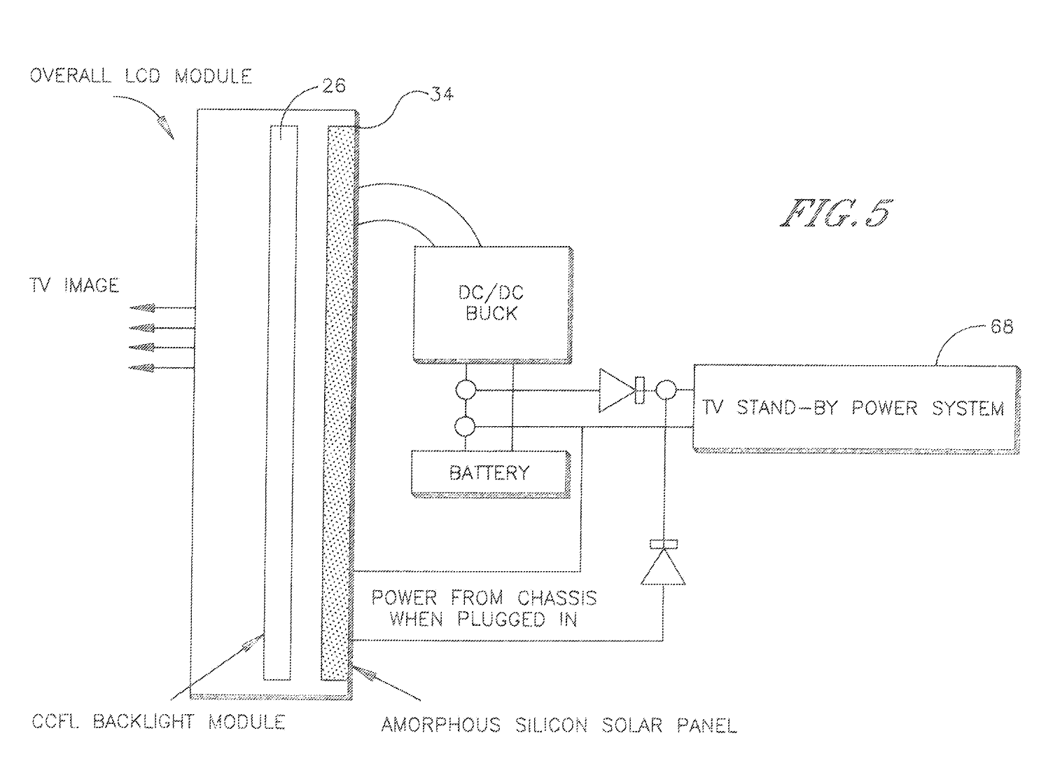

FIGS. 4 and 5 show alternate embodiments in which energy from the converter 34 is sent to a DC/DC/boost converter circuit or DC/DC buck converter circuit, respectively. Specifically, in FIG. 4 a DC/DC boost converter circuit 60 receives energy from the converter 34 and outputs a higher voltage than the input voltage to charge a standby power supply battery 62. The battery 62 provides power to a standby power supply circuit 64 when the TV is not energized, with the battery also receiving power from the TV when the TV is plugged in. As shown at nodes 66, the standby power supply system 64 can receive current directly from the boost circuit 60. FIG. 5 shows an essentially identical circuit as shown in FIG. 4 except that the DC/DC boost circuit 60 is replaced with a DC/DC buck converter circuit 68, which outputs a lower voltage from a higher voltage input.

What is claimed is:

1. TV comprising:
a chassis;
a TV liquid crystal display (LCD) mounted on the chassis;
a processor in the chassis;
a TV tuner receiving signals presentable on the LCD under control of the processor;
a light source in the chassis generating light to illuminate elements of the LCD;
at least one converter member disposed inside the chassis to receive light from the light source and convert the light into electricity; and
at least one standby power supply circuit in the chassis and receiving the electricity from the converter member.

2. The TV of claim 1, wherein the converter member includes at least one solar cell.

3. The TV of claim 2, wherein the chassis substantially blocks sunlight from impinging on the solar cell.

4. The TV of claim 1, wherein the standby power supply circuit includes a battery charged by the converter member, the standby power supply circuit providing standby power to process a wireless command signal received from a TV remote control when a main power supply to the light source is deenergized.

5. The TV of claim 1, wherein the light source is a cold cathode fluorescent lamp (CCFL).

6. The TV of claim 1, wherein the converter member is an amorphous silicon solar panel.

7. The TV of claim 1, wherein the standby power supply circuit includes a DC/DC buck/boost circuit receiving electricity from the converter member and communicating with a standby power supply battery.

8. Display apparatus comprising:
a chassis holding a display including display elements;
a light source in the chassis and positioned to provide illumination to the elements of the display, the illumination being necessary to cause the display to present demanded images, wherein some of the illumination is excess illumination that does not illuminate the elements of the display but nonetheless requires power to generate; and
a recycle circuit positioned in the chassis to receive and recycle the excess illumination so that not all of the excess illumination is wasted.

9. The apparatus of claim 8, wherein the recycle circuit includes at least one converter member disposed inside the chassis to receive light from the light source and convert the light into electricity.

10. The apparatus of claim 9, wherein the chassis substantially blocks sunlight from impinging on the converter member.

11. The apparatus of claim 1, wherein the recycle circuit includes a battery charged by the converter member, the battery providing standby power to process a wireless command signal received from a remote control when a main power supply to the light source is deenergized.

12. The apparatus of claim 8, wherein the light source is a cold cathode fluorescent lamp (CCFL).

13. The apparatus of claim 9, wherein the converter member is an amorphous silicon solar panel.

14. The apparatus of claim 9, wherein the recycle circuit includes a DC/DC buck/boost circuit receiving electricity from the converter member and communicating with a battery.

15. Display device, comprising:
an electronic display requiring illumination to present a demanded image;
a converter separate from the display and requiring illumination to generate electricity; and
at least one lamp providing illumination to the display to facilitate presentation of the demanded image thereon and providing illumination to the converter to facilitate electricity production thereby.

16. The display device of claim 15, comprising a chassis enclosing the converter and lamp and supporting the display.

17. The device of claim 16, wherein the chassis substantially blocks sunlight from impinging on the converter.

18. The device of claim 15, comprising a battery charged by the converter, the battery providing standby power to process a wireless command signal received from a remote control when a main power supply to the lamp is deenergized.

19. The device of claim 15, wherein the lamp is a cold cathode fluorescent lamp (CCFL) and the converter is an amorphous silicon solar panel.

20. Method comprising:
using a non-solar light source to illuminate a visual display to enable the display to produce a demanded image thereon; and simultaneously with using the non-solar light source to illuminate a visual display, using the non-solar light source to charge at least one battery.
